(19) United States
(12) Patent Application Publication
(10) Pub. No.: US 2012/0319001 A1
(43) Pub. Date: Dec. 20, 2012

(54) CHARGED PARTICLE BEAM LENS

(75) Inventor: Koichi Tsunoda, Yokohama-shi (JP)

(73) Assignee: CANON KABUSHIKI KAISHA, Tokyo (JP)

(21) Appl. No.: 13/493,833

(22) Filed: Jun. 11, 2012

(30) Foreign Application Priority Data
Jun. 15, 2011 (JP) 2011-133486

(51) Int. Cl. H01J 3/18

(52) U.S. Cl. 250/396 R

(57) ABSTRACT

An electrostatic charged particle beam lens in a charged particle beam exposure apparatus includes a first electrode having at least one aperture; a second electrode having at least one aperture; and a supporting body disposed between the first electrode and the second electrode, the supporting body being configured to support the first electrode and the second electrode such that the first electrode and the second electrode are electrically separated from each other. The supporting body is made of alkali-free glass or low-alkali glass.

### BACKGROUND OF THE INVENTION

1. Field of the Invention

The present invention relates to a technical field of an electron optical system included in an apparatus which uses charged particle beams, such as electron beams. In particular, the present invention relates to a charged particle beam lens which is an electron optical system included in an exposure apparatus.

2. Description of the Related Art

In manufacture of semiconductor devices, electron beam exposure techniques are major candidates for lithography which allows exposure of fine patterns of 0.1 μm or less. Electron beam exposure apparatuses use an electron optical element for controlling optical characteristics of electron beams. In particular, there are two types of electron lenses: electromagnetic type and electrostatic type. Unlike electron lenses of electromagnetic type, electron lenses of electrostatic type do not include a coil core and thus are relatively simple in structure. This is advantageous in downsizing. As an electron beam exposure technique, a multi-beam system has been proposed which is configured to simultaneously draw patterns with multiple electron beams, without using a mask. The number of electron lens arrays that can be placed inside a multi-beam exposure apparatus determines the number of electron beams, which is a major factor that determines the throughput. To achieve a throughput of 30 to 40 or more sheets per hour necessary for manufacturing semiconductor devices, the number of electron beams of the multi-beam exposure apparatus needs to be several hundred or more. It is thus important to realize a technique that reduces the size of electron lenses and produces a multi-lens having a high arrangement density.

Japanese Patent Laid-Open No. 2001-118491 discloses a multi-lens in which electrodes and a lens substrate that supports the electrodes are alternately stacked. The electrodes are provided with multiple apertures which allow passage of beams.

For an exposure apparatus equipped with a charged particle beam lens, drawing a fine pattern, for example, of 0.1 μm or less involves applying an electric field of 10 kV/mm or more between electrodes and shortening the focal length to sufficiently reduce the beam diameter. In this case, the focal length or distance to an object to be irradiated (hereinafter simply referred to as an object) is several hundred micrometers or less. In electrodes and a supporting body that constitute the charged particle beam lens, misalignment of components may cause aberration of beams on the surface of the object. Therefore, it is necessary that the components be aligned with high precision. With the configuration disclosed in Japanese Patent Laid-Open No. 2001-118491, it may be difficult to realize high-precision alignment under a high electric field condition. That is, due to unexpected discharge or aberration caused by misalignment, it may be difficult to draw a fine pattern.

A method for high-precision alignment is known in which electrodes made of silicon, which can be easily micromachined, and a supporting body made of glass are bonded together by anode coupling. This is because anode coupling typically has a high degree of precision in alignment. It is necessary that glass used in anode coupling contain an alkali metal component, such as sodium. The present inventor and others have found that in an exposure apparatus, if an electric field of 10 kV/mm or more is applied to an electrostatic charged particle beam lens including a glass member containing sodium, the exposure apparatus and an object may be contaminated with sodium ions deposited on the glass surface. In particular, if an electric field of 10 kV/mm or more is continuously applied, sodium ions are more likely to deposit. For example, for decomposition and removal of carbon contamination deposited on each component during a long period of use, the electronic apparatus may be subjected to plasma cleaning. However, such a cleaning process has been found to cause significant scattering of sodium ions on the glass surface and deteriorate contamination of an object, such as a silicon wafer, placed at a close distance. If a device, such as a metal oxide semiconductor (MOS) transistor, is made from a contaminated silicon wafer, the MOS transistor may suffer from malfunctions, such as an increase in leakage current and variation in threshold voltage.

### SUMMARY OF THE INVENTION

The present invention has been made to solve the problems described above. The present invention provides a charged particle beam lens that includes a first electrode having at least one aperture; a second electrode having at least one aperture; and a supporting body disposed between the first electrode and the second electrode, the supporting body being configured to support the first electrode and the second electrode such that the first electrode and the second electrode are electrically separated from each other. In the charged particle beam lens, the supporting body is made of alkali-free glass or low-alkali glass.

According to the charged particle beam lens described above, it is possible to reduce or prevent sodium deposition on the supporting body caused by application of a voltage between the first and second electrodes, reduce contamination of neighboring components, and facilitate maintenance of the apparatus.

Further features of the present invention will become apparent from the following description of exemplary embodiments with reference to the attached drawings.

### BRIEF DESCRIPTION OF THE DRAWINGS

FIG. 1 is a cross-sectional view of a charged particle beam lens according to the present invention.

FIG. 2 is a cross-sectional view of another charged particle beam lens according to the present invention.

FIG. 3 illustrates a configuration of a part of an exposure apparatus using a charged particle beam lens according to the present invention.

FIG. 4 is a cross-sectional view of another charged particle beam lens according to the present invention.

FIG. 5 illustrates a configuration of a multi-charged particle beam exposure apparatus according to the present invention.

FIG. 6 illustrates a configuration of a part of an exposure apparatus using a charged particle beam lens according to the present invention.

FIG. 7A is a simplified cross-sectional view of a charged particle beam lens according to the present invention, and FIG. 7B to FIG. 7D are enlarged views of area A in FIG. 7A.

FIG. 8A is a graph showing a relationship between the depth of a groove in a surface of a supporting body and the probability of escape of electrons from the surface of the supporting body, and FIG. 8B is a graph showing a relationship between a taper angle of a tapered part of the supporting body and charge variation on the surface of the supporting body.

### DESCRIPTION OF THE EMBODIMENTS

### Embodiment 1

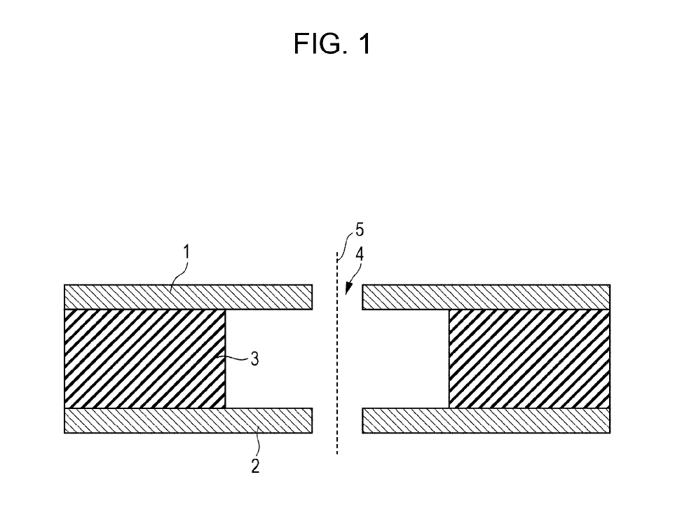

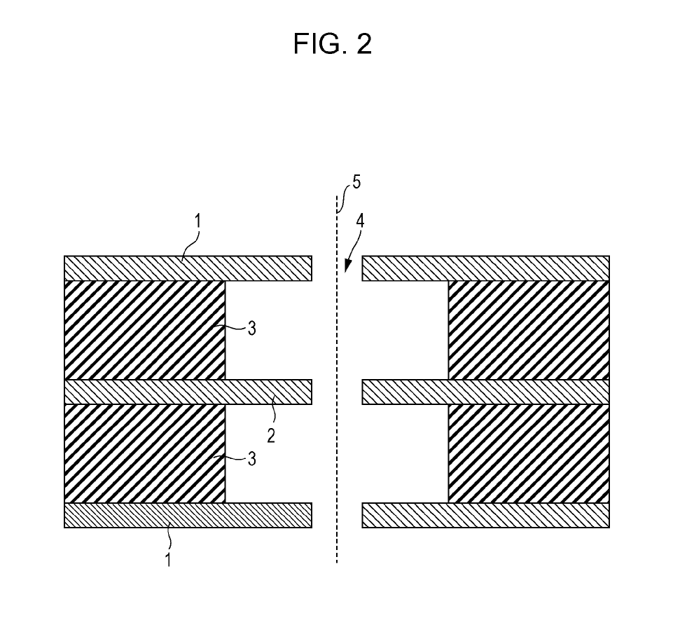

Embodiment 1 of the present invention will be described with reference to FIG. 1 and FIG. 2.

FIG. 1 and FIG. 2 each are a cross-sectional view for describing a basic configuration of a charged particle beam lens according to the present invention.

A charged particle beam lens of the present invention includes at least two electrodes, a first electrode 1 and a second electrode 2. The number of electrodes used in the present invention may be three or more, depending on the type or capability of the charged particle beam lens designed. The first electrode 1 and the second electrode 2 are electrically insulated from each other by a supporting body 3. The first electrode 1 and the second electrode 2 each are provided with at least one aperture 4 (or through hole), which allows passage of a charged particle beam emitted from a light source (or charged particle source) (not shown). The apertures 4 each function as a lens for a charged particle beam (typically an electron beam). The supporting body 3 is disposed such that it does not block the apertures 4 of the first electrode 1 and the second electrode 2. The supporting body 3 can be made of glass which contains little or no alkali metal. For using glass which contains little alkali metal, low-alkali glass containing less than 0.1 wt % alkali metal can be selected. The coefficient of linear expansion of this glass can be close to that of silicon to be bonded to the glass.

When used as an electrostatic lens, the charged particle beam lens may include three electrodes as illustrated in FIG. 2. FIG. 2 illustrates an Einzel electrostatic lens in which the first electrodes 1 and the supporting bodies 3 are symmetrically disposed with respect to the second electrode 2 illustrated in FIG. 1. In the case of FIG. 2, the second electrode 2 is interposed between the supporting bodies 3 on both sides, which are interposed between the first electrodes 1 on both sides. Then, for example, by applying a ground potential to the first electrodes 1 and applying a negative potential to the second electrode 2, the charged particle beam lens can function as an electrostatic lens. Although the first and second electrodes are used in the present embodiment, a third and other electrodes may be used as necessary.

In the electrostatic lens, which is the charged particle beam lens having the configuration described above, even if a voltage is applied between the electrodes during use, there is little or no sodium deposition from the supporting bodies 3. Therefore, there is virtually no contamination of neighboring components within the apparatus.

The phrase “there is virtually no contamination of neighboring components within the apparatus” refers not only to the case where neighboring components are not at all contaminated with sodium, but also to the case where the presence of sodium does not adversely affect characteristics of the neighboring components.

### Embodiment 2

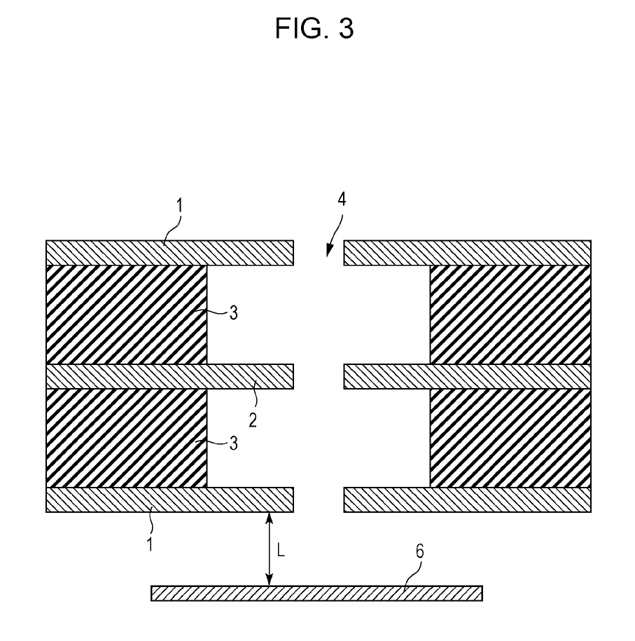

Embodiment 2 of the present invention will be described with reference to FIG. 3.

FIG. 3 is a cross-sectional view for describing a configuration in which an object (or exposure target) is exposed to charged particles from a charged particle beam exposure apparatus which includes a charged particle beam lens of the present invention. In FIG. 3, an object 6 to be irradiated with a charged particle beam is placed at a distance L from the electrostatic lens illustrated in FIG. 2. For example, the object 6 is a silicon wafer. Note that components having the same functions as those of Embodiment 1 are given the same reference numerals.

To focus a charged particle beam to a diameter of 0.1 μm or less with the electrostatic lens of the present embodiment, it is necessary to increase the voltage applied between electrodes. According to knowledge of the present inventor and others, the level of voltage that can be applied without causing discharge (or abnormal discharge) between electrodes is about 20 kV/mm. In that case, the focal length is about 200 μm. Therefore, when the object 6 is placed at a distance L of 200 μm or less from the surface of the first electrode 1, the object 6 can be stably irradiated with (or exposed to) a charged particle beam without causing discharge between electrodes. Moreover, since the supporting bodies 3 made of alkali-free glass are used, the object 6 can be prevented from being contaminated with sodium ions deposited from the supporting bodies 3. It is thus possible to improve the yield of devices produced on the object 6 without deteriorating their characteristics.

### Embodiment 3

In the present invention, for bonding between electrodes and supporting bodies, fusion bonding can be used for higher bonding precision. Embodiment 3 of the present invention will now be described with reference to FIG. 2.

For drawing fine patterns, it is necessary to reduce lens aberration to a desired pattern width or less. In the present embodiment, to reduce aberration caused by misalignment between the apertures 4 of the first and second electrodes 1 and 2, fusion bonding is performed after the first electrodes 1, the second electrode 2, and the supporting bodies 3 are aligned with high precision. In the present invention, the term “fusion bonding” refers to a bonding process in which, for example, after hydrophilic silicon, oxide silicon, or glass substrates are hydrogen-bonded, they are subjected to heat treatment and bonded together by Si—O—Si bonding.

Fusion bonding improves positional accuracy of the electrodes and supporting bodies of the charged particle beam lens, and improves the yield of the charged particle beam lens. The charged particle beam lens made by this manufacturing method can accommodate higher resolutions.

### Embodiment 4

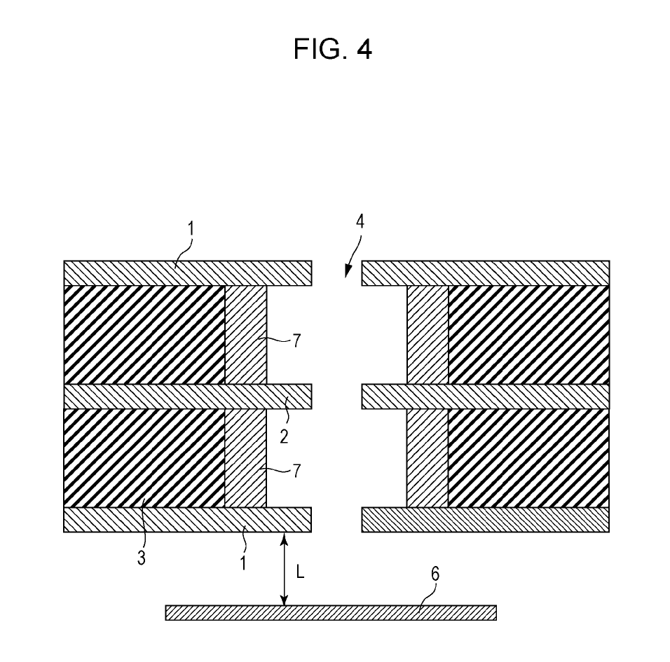

In the present invention, an antistatic film may be provided, as necessary, in a desired region on a surface of a supporting body. In the present invention, the term “antistatic film” refers to a film which is capable of preventing accumulation of more than a certain amount of charge, for example, on the surface of the supporting body. For example, if the surface of the supporting body is provided with an antistatic film, the amount of charge on the surface of the supporting body can be reduced. Embodiment 4 of the present invention will now be described with reference to FIG. 4.

In FIG. 4, an antistatic film 7 is provided on the surface of each supporting body 3. The other configurations are the same as those illustrated in FIG. 2. Note that components having the same functions as those of Embodiment 1 are given the same reference numerals.

Long periods of drawing with a charged particle beam may cause discharge between electrodes or between an electrode and a charged part. A careful study by the present inventor and others has revealed that the presence of minute defects in the electrodes or supporting body tends to cause the occurrence of such discharge. The surface of the supporting body 3 is charged by reflected electrons or secondary electrons from the object 6. This may combine with geometric concentration of an electric field caused by the defects and lead to the occurrence of discharge.

Such discharge can be suppressed by the antistatic film 7 on the surface of the supporting body 3. The antistatic film 7 can be made of, for example, an oxygen compound of aluminum and transition metal or a nitrogen compound of germanium and transition metal. By varying the content of the transition metal, it is possible to set a desired resistance value and adjust a charge eliminating function. The antistatic film 7 can be formed on the surface of the supporting body 3 by a thin-film forming technique, such as sputtering, reactive sputtering, electron beam evaporation, ion plating, ion assisted deposition, or chemical-vapor deposition (CVD).

In addition to the effect of Embodiment 1, the configuration including the antistatic film 7 makes it possible to eliminate charge on the surface of the supporting body 3 and suppress the occurrence of discharge between the first electrode 1 and the second electrode 2. It is thus possible to prevent the occurrence of discharge caused by manufacturing errors and defects and to improve the yield of devices.

### Embodiment 5

In the present invention, the amount of charge on the surface of the supporting body can be further reduced when the surface of the supporting body has a specific shape.

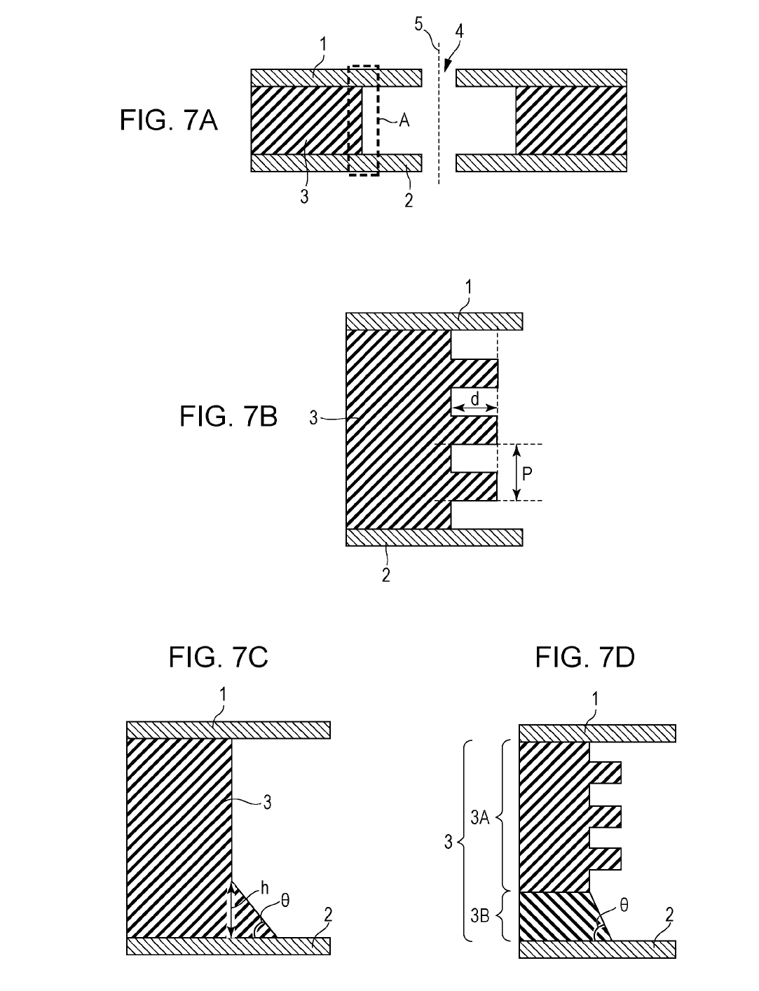

Embodiment 5 of the present invention will now be described with reference to FIG. 7A to FIG. 7D.

FIG. 7A is a simplified cross-sectional view of a charged particle beam lens according to the present embodiment. FIG. 7B to FIG. 7D are enlarged views of area A surrounded by a dotted line in FIG. 7A.

As described above, an electrostatic charged particle beam lens has a structure in which electrodes are stacked with an insulator interposed therebetween. When an electric field is applied between the electrodes, a contact of an insulator surface, an electrode surface, and a space is a specific point (hereinafter referred to as “triple junction”) where “insulator”, “electrode (or conductor)”, and “vacuum (or predetermined pressure atmosphere)” overlap each other. Generally, at the triple junction, the effect of electric field concentration facilitates emission of electrons from the electrode surface serving as a cathode. The emitted electrons directly collide with the insulator, or reach the anode and reflect back to enter the insulator. Thus, the supporting body surface, which is the insulator surface, is charged by the electrons. As a result, an electric field is generated by the charge on the insulator surface, and may deflect the orbit of electrons. Therefore, by suppressing the phenomenon in which the supporting body surface is charged by electrons emitted at the triple junction, it is possible to synergistically enhance the effect of the present invention.

As illustrated in FIG. 7A, the charged particle beam lens of the present embodiment includes two electrodes, the first electrode 1 and the second electrode 2. The first electrode 1 and the second electrode 2 are electrically insulated, separated, and supported by the supporting body 3 therebetween, with a predetermined positional relationship maintained. The apertures 4 of the first electrode 1 and the second electrode 2 allow passage of a charged particle beam emitted from a light source (not shown). The apertures 4 are positioned such that their central axis 5 is substantially common to both the first electrode 1 and the second electrode 2. The apertures 4 define the optical axis of the charged particle beam lens.

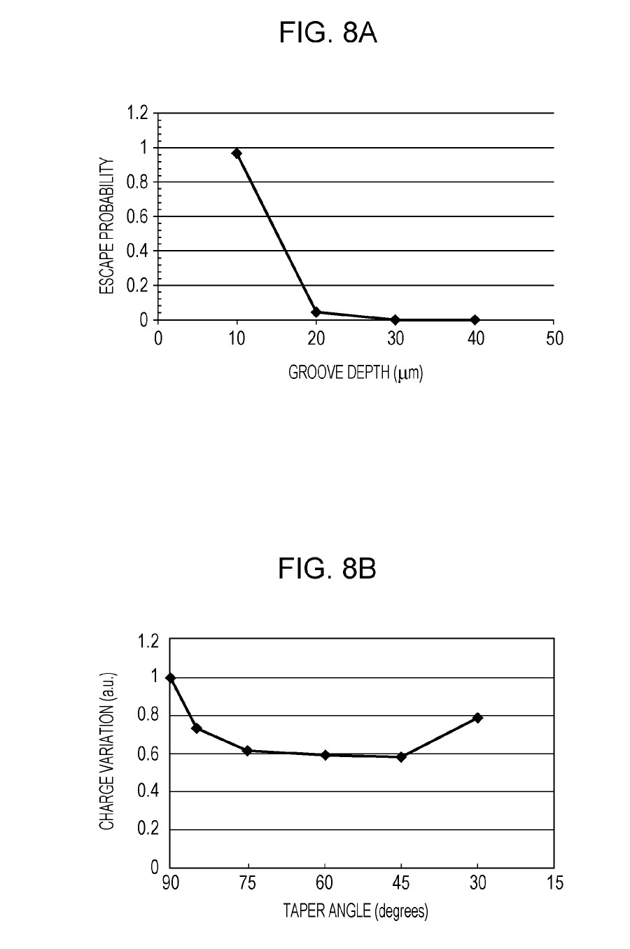

A desirable range of surface shapes of the supporting body 3 will now be described. For this study, a simulation was carried out in which an electrostatic field was calculated by a boundary element method and an electron orbit was calculated by a Monte Carlo method. FIG. 7B illustrates a configuration in which a surface of the supporting body 3 has a grooved structure (or non-planar part). In other words, the surface of the supporting body 3 has at least one raised or recessed portion. In FIG. 7B, the character “d” represents a level difference (μm) between a raised portion and a recessed portion, and the character “P” represents a pitch (μm) between adjacent raised portions. In FIG. 7B, P is 80 μm and the ratio of lengths of the raised and recessed portions is 1:1. First, a desirable range of the raised portion will be described with reference to FIG. 7B. The raised or recessed portion is configured to serve as a barrier in the direction of electron movement, so that electrons scattered from the cathode (second electrode 2) are prevented from repeatedly colliding with one another until they reach the anode (first electrode 1). However, if the barrier in the direction of electron movement is low in height, the electrons may go over the barrier and repeatedly collide with one another until they reach the anode. The ratio of electrons that go over the raised portion, illustrated in FIG. 7B, was calculated by varying the level difference d of the supporting body 3. FIG. 8A shows a result of the calculation. In FIG. 8A, the horizontal axis represents a level difference d (or groove depth) in micrometers (μm), and the vertical axis represents the ratio of electrons that go over the raised portion (or probability of escape of electrons). The calculation showed that if the level difference d is 20 μm, the ratio of electrons that go over the raised portion is substantially 0. Therefore, the level difference d can be set to 20 μm or more.

FIG. 7C illustrates a configuration in which an end portion of the supporting body 3 in contact with the second electrode 2 has a tapered structure (or is provided with a tapered part). The character θ in FIG. 7C represents a taper angle. The tapered part of the supporting body 3 has a height h of 80 μm. The function of the tapered part is to separate electrons from the supporting body 3 to suppress variation in charge state.

The amount of charge variation is calculated by varying the taper angle θ (in degrees) in FIG. 7C. FIG. 8B shows a result of the calculation. In FIG. 8B, the horizontal axis represents a taper angle in degrees, and the vertical axis represents a value relative to the amount of charge variation at a taper angle θ of 90° (taken as 1). FIG. 8B shows that a stable effect can be obtained when the taper angle θ ranges from 45° to 75°.

FIG. 7D illustrates a combination of the structures illustrated in FIG. 7B and FIG. 7C. As illustrated in FIG. 7D, the surface of the supporting body 3 extending between the first electrode 1 and the second electrode 2 is divided into a non-planar part 3A adjacent to the first electrode 1 and a tapered part 3B adjacent to the second electrode 2. The non-planar part 3A has raised (or recessed) portions, and the tapered part 3B has a tapered portion. The taper angle θ formed by the tapered part 3B and the surface of the second electrode 2 having the aperture 4 is larger than 0° and smaller than 90°. According to knowledge of the present inventor and others, a stable effect can be obtained when the taper angle θ ranges from 45° to 75°. The surface of the tapered part 3B may be curved or stepped as necessary. In the direction normal to the second electrode 2 (or in the direction of the optical axis along the central axis 5 of the aperture 4), an end position of the tapered part 3B in contact with the second electrode 2 and an end position (or top face position) of the raised portions of the non-planar part 3A are in substantially the same straight line. With this simple structure, the functions of the non-planar part 3A and the tapered part 3B can be effectively provided. In the present embodiment, the non-planar part 3A and the tapered part 3B are formed to be completely separated from each other. The raised portions of the non-planar part 3A extend substantially parallel to the surfaces of the first and second electrodes 1 and 2. In the present invention, the phrase “substantially parallel” refers not only to the case of being completely parallel, but also to the case of being non-parallel and to the case where a plurality of raised portions protrude non-parallel to each other, as long as the effect of the present invention can be achieved. Therefore, it is acceptable that the raised portions of the non-planar part 3A be non-parallel to the surfaces of the first and second electrodes 1 and 2, either intentionally for design purposes or due to processing errors, as long as the effect of the present invention can be achieved. According to knowledge of the present inventor and others, even with an inclination of ±1°, the raised portions of the non-planar part 3A can be regarded as being substantially parallel to the surfaces of the first and second electrodes 1 and 2.

### Embodiment 6

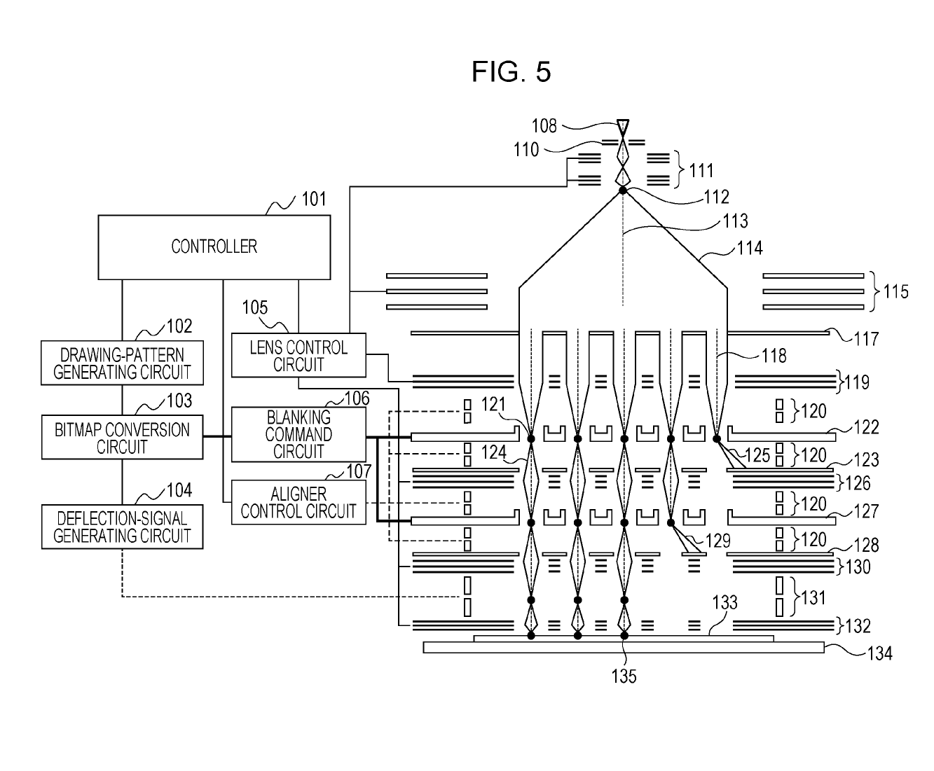

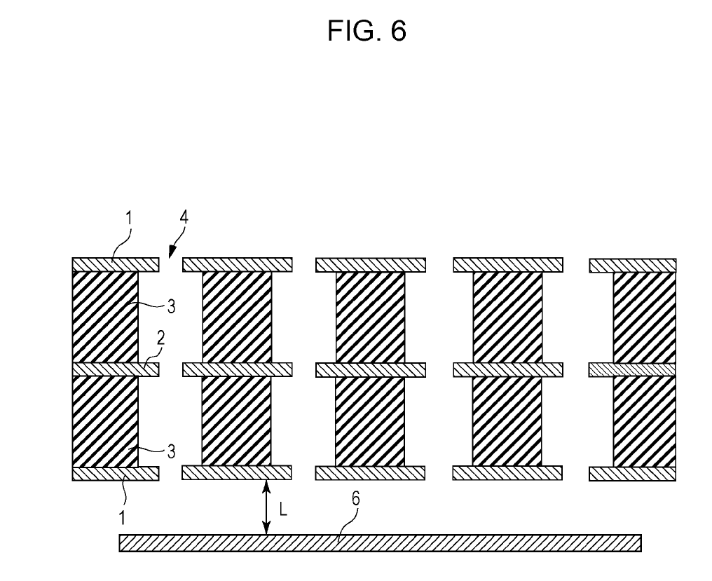

A specific configuration of an exposure apparatus including a charged particle beam lens of the present invention will be described as Embodiment 6 with reference to FIG. 5 and FIG. 6.

First, a configuration of a multi-charged particle beam exposure apparatus will be described with reference to FIG. 5.

An electron beam emitted from an electron source 108 by an anode electrode 110 is formed into a crossover 112 by a crossover alignment optical system 111 which allows the charged particle beam lens to focus the electron beam into a real image. A so-called thermionic electron source, such as an LaB6 or BaO/W cathode (dispenser cathode), is used as the electron source 108.

The crossover alignment optical system 111 is a two-stage electrostatic lens. The first and second stage electrostatic lenses each include three electrodes and are electrostatic lenses of so-called Einzel type, in which the intermediate electrode is supplied with a negative voltage whereas the upper and lower electrodes are grounded.

Electron beams 113 and 114 diverging from the crossover 112 are turned into parallel beams by a collimating lens 115. The beams obtained by the irradiation electron optical system up to this point are applied to an aperture array 117. The applied beams are divided by the aperture array 117 into multi-electron beams 118, which are individually focused by a first focusing lens array 119 into images on a first blanker array 122.

In the present embodiment, the first focusing lens array 119 is composed of electrostatic lenses, each including three porous electrodes. The electrostatic lenses are of so-called Einzel type, in which only the intermediate electrode of the three electrodes is supplied with a negative voltage whereas the upper and lower electrodes are grounded.

Since the aperture array 117 serves also to define the numerical aperture (NA) or angular aperture, the aperture array 117 is disposed at the position of the pupil plane (or front focal plane) of the first focusing lens array 119.

The first blanker array 122 includes devices each having an individual deflection electrode. In accordance with a blanking signal generated by a drawing-pattern generating circuit 102, a bitmap conversion circuit 103, and a blanking command circuit 106, the first blanker array 122 turns on and off the multi-electron beams 118 individually depending on the drawing pattern.

If the multi-electron beam 118 is in the on-state, no voltage is applied to the corresponding deflection electrode of the first blanker array 122. If the multi-electron beam 118 is in the off-state, a voltage is applied to the corresponding deflection electrode of the first blanker array 122 to deflect the multi-electron beam 118. The multi-electron beam 118 deflected by the first blanker array 122 into a multi-electron beam 125 is shut off and turned into the off-state by a first stop aperture array 123 downstream of the first blanker array 122.

In the present embodiment, a blanker array is composed of two stages. A second blanker array 127 and a second stop aperture array 128 having the same structures as those of the first blanker array 122 and the first stop aperture array 123 are disposed downstream of the first blanker array 122 and the first stop aperture array 123.

Multi-electron beams 124 passed through the first blanker array 122 are formed by a second focusing lens array 126 into images on the second blanker array 127. A multi-electron beam 129 deflected by the second blanker array 127 is shut off and turned into the off-state by the second stop aperture array 128 downstream of the second blanker array 127. Multi-electron beams passed through the second blanker array 127 are focused by a third focusing lens array 130 and a fourth focusing lens array 132 and formed into images on a wafer 133. The second focusing lens array 126, the third focusing lens array 130, and the fourth focusing lens array 132 are arrays of Einzel electrostatic lenses, as in the case of the first focusing lens array 119. The first focusing lens array 119, the second focusing lens array 126, the third focusing lens array 130, and the fourth focusing lens array 132 are connected to a lens control circuit 105, which controls the electron optical power (or focal length). An aligner 120 for optical axis alignment is disposed between the first focusing lens array 119 and the first blanker array 122, between the first blanker array 122 and the first stop aperture array 123, between the second focusing lens array 126 and the second blanker array 127, and between the second blanker array 127 and the second stop aperture array 128. The aligners 120 are connected to an aligner control circuit 107, by which the optical axis alignment is carried out.

The fourth focusing lens array 132 includes objective lenses having a magnification of about 0.01. Thus, an electron beam 121 (whose spot diameter is 2 μm in full width at half maximum (FWHM)) in an intermediate image plane of the first blanker array 122 is reduced to 1/100, that is, to a multi-electron beam of about 20 nm in FWHM on the wafer 133.

Scanning with a multi-electron beam over the wafer 133 can be performed by a deflector 131. More than one deflector 131 may be provided depending on the number of electron beams. For a single electron beam, at least one deflector 131 is provided. The deflector 131 includes counter electrodes. For two-stage deflection in both the X and Y directions, the deflector 131 is composed of a four-stage counter electrode. For simplicity, a two-stage deflector is represented as a single unit in FIG. 5. The deflector 131 is driven in accordance with a signal from a deflection-signal generating circuit 104.

During pattern drawing, the wafer 133 is continuously moved by a stage 134 in the X direction, while electron beams 135 on the surface of the wafer 133 are deflected in the Y direction by the deflector 131 on the basis of a result of real-time length measurement made by a laser-length measuring machine. At the same time, by the first blanker array 122 and the second blanker array 127, beams are individually turned on and off depending on the drawing pattern. Thus, a desired pattern can be drawn on the wafer 133 at high speed. The overall control is done by a controller 101.

The present embodiment is realized when the electrostatic lens of Embodiment 2 and the object 6 are provided as the fourth focusing lens array 132 and the wafer 133, respectively, in the exposure apparatus described above. The electrostatic lens of Embodiment 2 may be provided not only as the fourth focusing lens array 132, but also as each of the first, second, and third focusing lens arrays 119, 126, and 130. In the present embodiment, the object 6 is not contaminated and the number of defective devices can be reduced. It is thus possible to realize a multi-beam exposure apparatus with improved yield.

A specific configuration of the present invention will now be described in detail using examples. Note that the present invention is not limited to such examples.

### Example 1

A specific configuration of Example 1 will be described with reference to FIG. 2. The first electrode 1 and the second electrode 2 are 4 inches in diameter and are made of monocrystal silicon polished on both sides. Both the first electrode 1 and the second electrode 2 have a thickness of 100 μm. The first electrode 1 and the second electrode 2 each have the aperture 4 (or through hole) having a diameter of 30 μm. The supporting body 3 is 4 inches in diameter (equal to that of the first electrode 1 and the second electrode 2), 400 μm in thickness, and is made of EAGLE XG (registered trademark) which is alkali-free glass containing no alkali metal. The supporting body 3 is provided with a through hole at a position corresponding to the through holes of the first electrode 1 and the second electrode 2. The supporting body 3 is configured such that it does not block the space between the through holes of the first electrode 1 and the second electrode 2. In other words, the supporting body 3 is configured to support the areas around the through holes of the first electrode 1 and the second electrode 2. In the present embodiment, the through hole (or aperture) of the supporting body 3 has a diameter of 4 mm. The supporting body 3 is interposed between the first electrode 1 and the second electrode 2, which are disposed parallel to a plane whose normal line is the central axis 5 of the apertures 4.

A method for manufacturing the charged particle beam lens of the present example will now be described.

A silicon wafer is used as a material of the first electrode 1 and the second electrode 2. The through holes of the first electrode 1 and the second electrode 2 are formed by applying high-precision photolithography and dry etching to the silicon wafer. The through hole of the supporting body 3 made of glass is formed by sandblasting. Microcracks and burrs on the processed surface of the supporting body 3 are removed by wet etching and surface polishing. The first electrode 1, the second electrode 2, and the supporting body 3 processed as described above are sufficiently aligned and bonded together. A heat resistant silicone adhesive is used for the bonding.

The electrostatic lens described above was placed in the exposure apparatus, where a ground potential was applied to the first electrode 1 and a voltage of −3.7 kV was applied to the second electrode 2. The accelerated test at 200° C. reveals that even after the elapse of 10000 hours at ambient temperature, the amount of sodium deposited near the second electrode 2 did not exceed 1×10⁹ (atoms/cm²), which is the detection limit of the time-of-flight secondary ion mass spectrometry (TOF-SIMS). This shows that the exposure apparatus was not contaminated.

### Example 2

Example 2 will be described with reference to FIG. 3. The materials, dimensions, and manufacturing method of Example 2 are the same as those of Example 1, except for those described below.

The electrostatic lens described above was placed in the exposure apparatus, and the object 6 was placed at a distance L of 200 μm from the surface of the first electrode 1. Then, a pattern was drawn on the object 6 with a charged particle beam. The same analysis as that performed in Example 1 was performed on the object 6, and revealed that no contamination occurred.

### Example 3

Example 3 will be described with reference to FIG. 3. The materials, dimensions, and manufacturing method of Example 3 are the same as those of Example 2, except for those described below.

In Example 3, fusion bonding was used as a method for bonding the first electrode 1, the second electrode 2, and the supporting body 3 together. Fusion bonding is a technique in which, after hydrophilic silicon or oxide silicon substrates are hydrogen-bonded, they are subjected to heat treatment and bonded together by Si—O—Si bonding. This technique is mainly used for bonding silicon wafers, at least one of which is oxidized. Therefore, this technique is suitable for use in the present invention, where silicon electrodes and a glass supporting body are bonded with high precision. In this technique, after application of plasma oxidation, the processing temperature may be lowered by bonding. In the present example, first, the bonding surfaces of the first electrode 1 and the supporting body 3 were cleaned, activated by oxygen plasma, and bonded together at ambient temperature. Likewise, the second electrode 2 was bonded to the surface of the supporting body 3 remote from the first electrode 1. Then, the stacked components were annealed at 400° C. and bonded together.

The accuracy of alignment of the first electrode 1, the second electrode 2, and the supporting body 3 of the electrostatic lens of the present example was measured in length by a laser microscope. This shows that the number of positional inaccuracies in Example 3 is smaller than that in Example 2.

### Example 4

Example 4 will be described with reference to FIG. 4. The materials, dimensions, and manufacturing method of Example 4 are the same as those of Example 2, except for those described below.

A film having a thickness of 300 nm was formed on the surface of the supporting body 3. Tungsten and aluminum were used as materials of the film. A compound of tungsten and aluminum oxide was formed into the film by reactive sputtering.

A voltage of 20 kV/mm was applied between the first electrode 1 and the second electrode 2 of the electrostatic lens, which was then operated within the exposure apparatus. As a result, no discharge was observed during exposure.

### Example 5

Example 5 will be described with reference to FIG. 7A to FIG. 7D. A charged particle beam lens having the structure of FIG. 7D was prepared. In the present example, both the first electrode 1 and the second electrode 2 are made of monocrystal silicon and are 100 μm in thickness. The aperture 4 is 30 μm in diameter. The supporting body 3 is 4 inches in diameter (equal to that of the first electrode 1 and the second electrode 2), 400 μm in thickness, and is made of EAGLE XG (registered trademark) which is alkali-free glass containing no alkali metal. The supporting body 3 is interposed between the first electrode 1 and the second electrode 2, which are disposed parallel to a plane whose normal line is the central axis 5 of the apertures 4. The surface of the non-planar part 3A of the supporting body 3 adjacent to the first electrode 1 is provided with three raised portions. The height of each raised portion (or the level difference between the bottom of a recessed portion and the top face of a raised portion) is 20 μm. The tapered part 3B of the supporting body 3 adjacent to the second electrode 2 forms an angle of 75° with the second electrode 2. A ground potential was applied to the first electrode 1 and a voltage of −3.7 kV was applied to the second electrode 2. The level of fluctuations in the amount of deflection of an electron beam passing through the aperture 4 was measured. This shows that the level of fluctuations in Example 5 is lower by 80% than that in the case of the supporting body 3 with a smooth surface. The accelerated test at 200° C. reveals that even after the elapse of 10000 hours at ambient temperature, the amount of sodium deposited near the second electrode 2 did not exceed 1×10⁹ (atoms/cm²), which is the detection limit of the time-of-flight secondary ion mass spectrometry (TOF-SIMS). This shows that the exposure apparatus was not contaminated.

### Example 6

FIG. 6 illustrates a charged particle beam lens of Example 6. Except that the apertures 4 of the first and second electrodes 1 and 2 are arranged in four lines, the charged particle beam lens illustrated in FIG. 6 is the same as that illustrated in FIG. 3. Note that components having the same functions as those described with reference to FIG. 3 are given the same reference numerals. In Example 6, the charged particle beam lens illustrated in FIG. 6 was provided as each of the first, second, third, and fourth focusing lens arrays 119, 126, 130, and 132 in the multi-charged particle beam exposure apparatus described above, and exposure was performed. As a result, the fact that no sodium was present on the object 6 was proven by the same method as that of Example 2.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-133486 filed Jun. 15, 2011, which is hereby incorporated by reference herein in its entirety.

What is claimed is:

1. A charged particle beam lens comprising:
a first electrode having at least one aperture;
a second electrode having at least one aperture; and
a supporting body disposed between the first electrode and the second electrode, the supporting body being configured to support the first electrode and the second electrode such that the first electrode and the second electrode are electrically separated from each other,
wherein the supporting body is made of alkali-free glass or low-alkali glass.

2. The charged particle beam lens according to claim 1, wherein the first electrode or the second electrode is fusion-bonded to the supporting body.

3. The charged particle beam lens according to claim 1, wherein a surface of the supporting body is at least partially provided with an antistatic film.

4. The charged particle beam lens according to claim 1, wherein the supporting body includes a non-planar part and a tapered part, the non-planar part having at least one raised or recessed portion; and
a taper angle formed by the tapered part and a surface of the second electrode having the aperture is larger than 0° and smaller than 90°.

5. The charged particle beam lens according to claim 1, wherein the supporting body is made of glass containing less than 0.1 wt % alkali metal.

6. The charged particle beam lens according to claim 1, wherein the supporting body has at least one aperture, wherein a portion of the aperture of the supporting body has a level different from another portion of the aperture of the supporting body.

7. The charged particle beam lens according to claim 1, wherein the supporting body has at least one aperture, wherein a portion of the aperture of the supporting body has a taper.

8. The charged particle beam lens according to claim 1, wherein the supporting body has at least one aperture and the glass surface of the aperture of the supporting body contains less than 0.1 wt % alkali metal.

9. A charged particle beam exposure apparatus comprising:
a charged particle source;
an irradiation electron optical system configured to apply a charged particle beam emitted from the charged particle source;
a substrate having a plurality of apertures, the substrate being irradiated with the charged particle beam from the irradiation electron optical system;
at least one deflector configured to individually deflect charged particle beams from the plurality of apertures of the substrate to control blanking; and
a plurality of charged particle beam lenses each lens comprising:
a first electrode having an aperture;
a second electrode having an aperture; and
a supporting body disposed between the first electrode and the second electrode, the supporting body being configured to support the first electrode and the second electrode such that the first electrode and the second electrode are electrically separated from each other,
wherein the supporting body is made of alkali-free glass or low-alkali glass.
